(19) United States
(12) Patent Application Publication
(10) Pub. No.: US 2005/0056764 A1
(43) Pub. Date: Mar. 17, 2005

(54) Cable support structure and apparatus and method for making

(76) Inventor: William J. Thompson, Fullerton, CA (US)

Correspondence Address: SNELL & WILMER LLP, 1920 MAIN STREET, SUITE 1200, IRVINE, CA, 92614-7230, US

(21) Appl. No.: 10/824,787

(22) Filed: Apr. 15, 2004

Related U.S. Application Data
(63) Continuation-in-part of application No. 10/663,511, filed on Sep. 16, 2003.

(51) Int. Cl. F16L 3/00

(52) U.S. Cl. 248/547; 248/62; 248/339

(57) ABSTRACT

A combination of an electrical cable hanger, anchor assembly and coupling assembly, and methods of forming and using such a combination. The hanger is preferably formed from a wire rod and is shaped to be fastened to a surface/substrate such as a concrete, wood, or metal overhead deck or side wall. The hanger preferably comprises an integral fastening loop and stabilizing segment at one end that provides a stabilizing footprint on the substrate. The coupling assembly couples the anchor assembly to the fastening loop, is suitable for use with a variety of fastener types, and facilitates the use of a rigid hanger as well as rigidly coupling the hanger to the side wall, deck, or other surface.

This application is a continuation-in-part of U.S. application Ser. No. 10/663,511, filed Sep. 16, 2003, currently co-pending and hereby incorporated by reference in its entirety.

### BACKGROUND OF THE INVENTION

1. Field of the Invention

The present invention relates generally to improvements in cable support structures and more particularly pertains to new and improved apparatus for suspending cables in office buildings.

2. Description of the Related Art

The apparatus of U.S. Pat. No. 6,364,266 ('266), issued Apr. 2, 2002 provides a good example of an apparatus that would benefit by the improvements disclosed herein. In '266, a one piece wire hanger is directly mounted by an installation gun to support electrical wires to a flat surface such as ceiling or a wall. FIGS. 1, 2, and 3 herein illustrate the apparatus of the '266 patent. In FIG. 1, a plurality of hangers 100 are used to hang wire 170 from surface 180, the hangers 100 being installed through the use of an installation tool 190. In FIG. 2, driving pin 111 is forced partially into a circular plate 112 which is welded to terminal 101 of hanger. In FIG. 3, the hanger is showed mounted to surface 190. In the description, the '266 patent teaches that the inner diameter of terminal 101 is preferred not to exceed 0.265 inches.

Unfortunately, the apparatus of the '266 patent is not suitable for all the applications that the apparatus disclosed herein is particularly well suited for. Whether it was heretofore realized or not, requiring the use of a pin (111) forced into a plate (112) renders the apparatus unsuitable for use when a pin (111) is insufficient to properly anchor a hanger (100). Additionally, having to include a plate (112) and having to weld it to the hanger (100) can add significant cost to the production of the hanger (100). Moreover, having a terminal (101) with an inner diameter that doesn't exceed 0.256 inches makes it impractical to use larger diameter rods in forming the hanger. Still further, having the terminal (101) directly contact the surface (180) it is being mounted to while a pin (111) is driven into the surface (180) may result in the terminal (101) and/or hanger (100) not being as tightly coupled to the surface (180) as it could be, and might result in a coupling that insufficiently resists rotation around the pin (111). As such, there is a need for improved support structures that are suitable for use with multiple types of fasteners, provide sufficient rigidity, and better resist rotation around a fastener.

### SUMMARY OF THE INVENTION

The present invention is directed to a combination of a cable hanger, anchor assembly and coupling assembly as well as the formation and use of such a combination. The hanger is preferably formed from a wire rod and is shaped to be fastened to a surface/substrate such as a concrete, wood, or metal overhead deck or side wall. The hanger preferably comprises an integral fastening loop and stabilizing segment at one end that provides a stabilizing footprint on the substrate. The coupling assembly couples the anchor assembly to the fastening loop, is suitable for use with a variety of fastener types, facilitates the use of a rigid hanger, and also facilitates rigidly coupling the hanger to the side wall, deck, or other surface.

The present invention may be characterized as a support structure for suspending electronic cable in the plenum above a suspend ceiling attached to an upper support, the support structure for electronic cable comprising: a unitary structure having a drop segment extending downward from a stabilizing segment, the stabilizing segment oriented to lay against the upper support, the stabilizer segment formed into a loop at its end; and a coupling mechanism for attaching the stabilizing segment to the upper support by the loop in the stabilizing segment. Alternatively, the present invention may be characterized as a cable support structure comprising a unitary support member, a fastener assembly having a portion projecting outward from the support member, and a coupling assembly adapted to couple the fastener assembly to the support member, the coupling assembly comprising a flange positioned opposite the projection portion of the fastener assembly.

### BRIEF DESCRIPTION OF THE DRAWINGS

The exact nature of this invention, as well as its objects and advantages, will become readily apparent upon consideration of the following description of a preferred embodiment of the invention as illustrated in the accompanying sheets of drawings in which:

FIG. 1 is a an illustration of the use of a prior art device.

FIG. 2 is an illustration of the device used in FIG. 1.

FIG. 3 is a detailed view of the device of FIGS. 1 and 2.

FIG. 4 is a perspective illustration of a preferred embodiment of the present invention.

FIG. 5 is an exploded view of the embodiment of FIG. 4.

FIG. 6 is detail view of an alternative fastening loop.

FIG. 7 is detail view of an alternative fastening loop.

FIG. 8 is a cutaway detail view of an preferred base.

FIG. 9 is a cutaway detail view of an alternative base.

FIG. 10 is a cutaway detail view of an alternative base.

FIG. 11 is a cutaway detail view of an alternative base.

FIG. 12 is a perspective view of another preferred embodiment of the present invention.

FIG. 13 is a cutaway detail view of a preferred coupling mechanism.

FIG. 14 is a cutaway detail view of an alternative coupling mechanism.

FIG. 15 is a cutaway detail view of an alternative coupling mechanism.

FIG. 16 is a cutaway detail view of an alternative coupling mechanism.

FIG. 17 is a cutaway detail view of an alternative coupling mechanism.

FIG. 18 is a cutaway detail view of an alternative coupling mechanism.

FIG. 19 is a detailed cutaway view of a mounting structure about to be coupled to a surface.

FIG. 20 is a detailed cutaway view of the structure of FIG. 19 coupled to the surface.

FIG. 21 is a detailed cutaway view showing an alternative coupling of the structure of 19 to the surface.

FIG. 22 illustrates an alternative fastener assembly.

FIG. 23 illustrates an alternative fastener assembly.

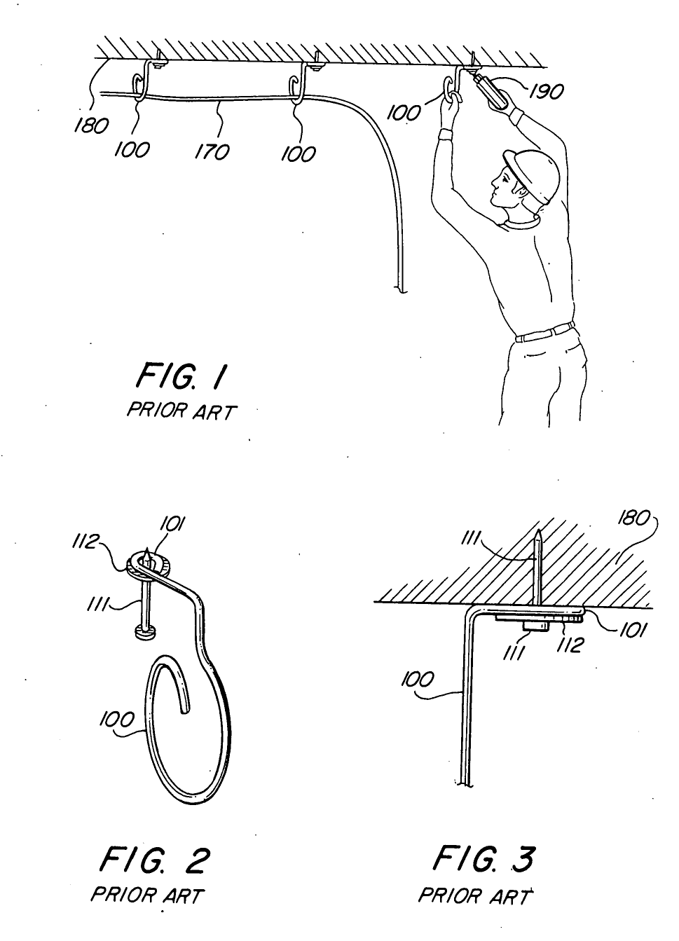

### DETAILED DESCRIPTION OF THE PREFERRED EMBODIMENTS

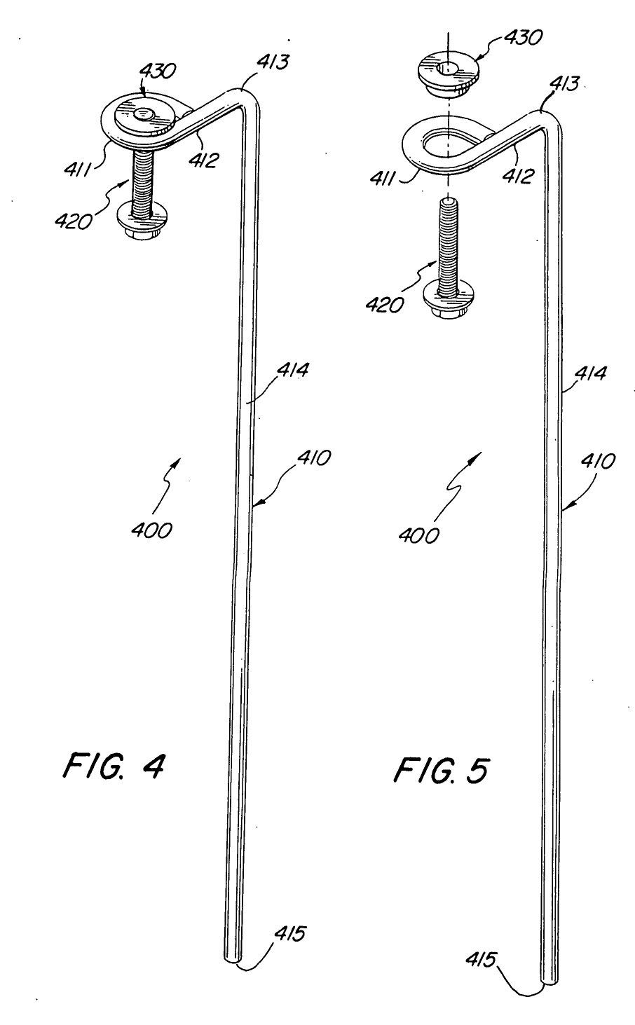

The preferred embodiment of a support assembly 400, as illustrated in FIGS. 4 and 5, comprises a support 410, a fastener assembly 420, and a fastener coupling mechanism 430 that couples fastener assembly 420 to support 410. Assembly 400 is particularly well suited for use as an electrical cable support assembly, particularly as a communication digital audio/video cable support assembly, but may be used in other applications as well if there is a need for a rigid support member to be coupled to a surface.

The support 410 has a small fastening loop 411 formed at its first end that transitions into a stabilizing segment 412 extending from the fastening loop 411 to a 900 bend 413, and extends via a drop segment 414 from bend 413 to its second end 415. Fastener assembly 420, which will typically comprise a fastener such as a ramset or drill screw, is held to the fastening 411 by the flange of the coupling mechanism 730 on one side the head of the fastener, by the body of the coupling mechanism 730 pressing against the sides of the loop, and/or in some instances by a washer or plate adjacent the head on a side opposite the flange.

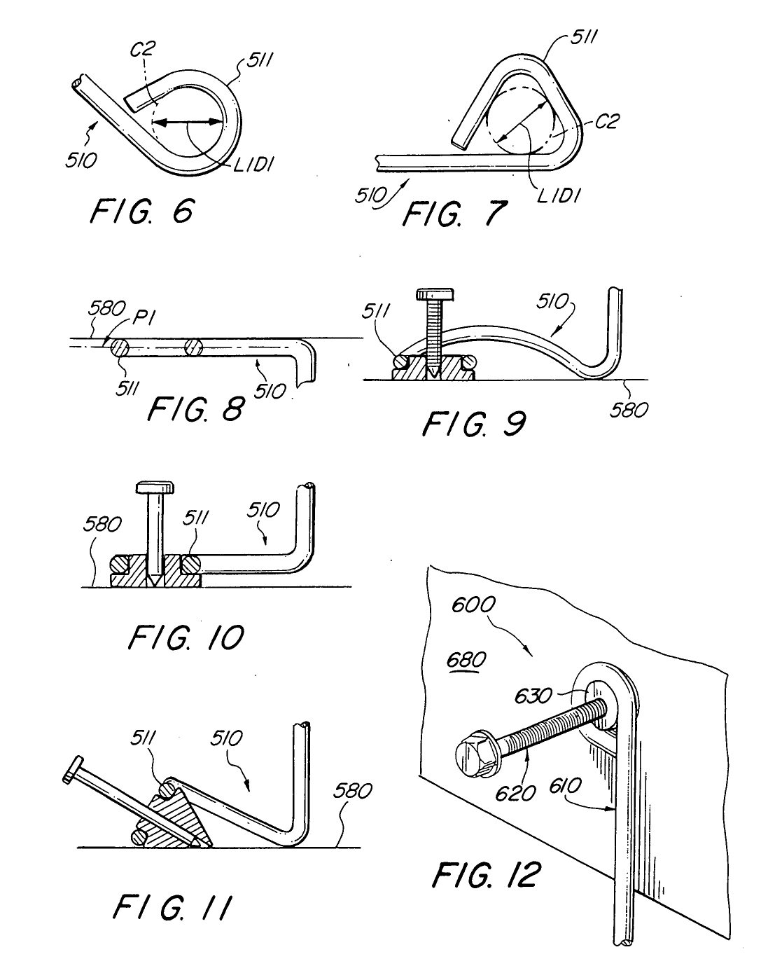

In alternative embodiments, the fastening loop (411 in FIGS. 4 and 5) may be circular, triangular, or some other shape. FIGS. 6 and 7 illustrate loops having a tear drop and a triangular shape respectively. Fastening loops are described herein as having inner diameters. For fastening loops formed by bending a rod into a circular shape, what constitutes an inner diameter is self evident. However, as shown in FIGS. 6 and 7, for alternative shapes, the inner diameter is the diameter LID1 of the largest cylinder C2 can pass through the loop 511.

In preferred embodiments, the support 410 will be formed from a uniform, cylindrical rod, and the fastening loop will be planar in that the center line of the rod forming the loop will form a planar curve. Moreover, it is preferred that the center line of the stabilizing segment lie in the same plane as that defined by the center line of the fastening loop. However, it is contemplated that limitations in manufacturing capabilities (and possibly attempts to introduce insignificant changes to circumvent the claims herein) will often result in irregularities that result in a centerline that is non-planar. In such instances, the plane of the loop may in some instances be considered to be a reference plane positioned to intersect the loop centerline at the maximum possible number of points.

Referring back to FIGS. 4 and 5, the “base” of support 410 comprises the fastening loop 411, stabilizing segment 412, and at least a portion of the bend 413. For maximum stabilization, it is preferred that the base be planar, i.e. that the centerline of the portion of the rod forming the base forms a planar figure as illustrated by plane P1 in FIG. 8. However, it is contemplated that in many instances the base will not truly be planar. If not truly planar, it is preferred that the base, when placed flush against a planar surface with the drop segment projecting parallel to or away from the surface, will contact the surface in at least three points, ideally at least two non-adjacent points on the fastening loop and one point at or near the bend. In some instances, the base may be intentionally non-planar, possibly to compensate for a coupling mechanism that prevents all or part of the fastening loop from contacting the surface as illustrated in FIG. 9, and possibly to insure that a fastener is not perpendicular to the surface. In some instances, the base may only contact the surface at two points, a single point, or not at any points. In such instances, it is preferred that the coupling mechanism have sufficient contact with the surface to stabilize the support member such as is illustrated in FIGS. 10 and 11.

Although the dimensions of the base will likely vary between embodiments, it is contemplated that preferred bases will have a length (the greatest distance between any two points on the base, typically one on the fastening loop and one on or near the bend) of at least 1.5 inches, preferably at least 1.75 inches, will have a fastening loop outer diameter or width of at least 0.75 inches (typically twice the diameter of the rod plus the inner diameter of the loop), and possibly at least 0.80, 0.85, or 0.90 inches, and will have a rod diameter of at least 0.24 inches. In at least some embodiments a base will have a rod diameter between about 0.246 and 0.252 inches, a fastening loop inner diameter between about 0.250 and 0.375 inches, and a length between about 1.5 and 2.0 inches.

It is contemplated that non-planar bases may be more suitable for use on marginally planar or non-planar surfaces. If fastening to non-planar surfaces, it is preferred that the base be shaped to contact the surface at as many points as possible. In some instances, this would involve utilizing a base shaped to conform to the shape of the surface such as the use of a curved base to couple to a cylindrical pillar.

Referring back to FIGS. 4 and 5, the support 410 is particularly well suited for use as an overhead attachment to a horizontal deck in that it includes the 90° bend 413 that would cause the drop segment to 414 project downward (or upward) from such a surface, but is also suitable for use on non-horizontal surfaces as well. Alternative embodiments may, in addition to any bend or bends used to form a fastening loop, have a bend 413 that is less than or greater than 90°, may not include any bends, or may have two or more bends. Moreover, such embodiments or additional embodiments may have a non-linear drop segment.

Embodiments without any bends such as that of FIG. 12 may be particularly suitable for attachment to overhead side walls. In FIG. 12, support assembly 600 is similar to assembly 400 of FIGS. 4 and 5 in that it includes a support 610, a fastener assembly 620, and a coupling assembly 630, but is coupled to a vertical surface 680 rather than a horizontal surface.

Referring back to FIGS. 4 and 5, in some instances, the end of the drop segment 414 may be straight, or may be bent or otherwise modified to adapt support 410 to a particular purpose. As an example and as described in co-pending application Ser. No. 10/663,511 (incorporated herein by reference in its entirety), the end of drop segment 414 opposite bend 413 may be formed into a larger loop which has a saddle of a very specific construction integral with the shaft. As such, alternative contemplated embodiments to those described herein are embodiments which are formed by combining any one or more features described herein with any one or more features described in the '511 application.

The unitary structure of the support 410 is a significant advantage in an environment where support sways and sturdiness is an important consideration. The unitary construction of the support 410 also is of significant advantage from the standpoint of its manufacture, in that it can be made simply, quickly and cheaply by a simple hand-operated apparatus in a manner similar to that described in co-pending application '511. As such, support 410 is preferably formed by bending a straight rod twice, once to form the fastening loop, and a second time to add the bend between the stabilizing and drop segments. However, it is contemplated that alternative methods of formation, such as casting, may be used to form support 410.

Support 410 preferably comprises an 8-gauge or higher, zinc plated mild steel rod or similar shaft. Although preferably round, the support 410 may be triangular, rectangular, hexagonal, or any other reasonable shape. For drop lengths (the length of drop segment 414) greater than one foot, a 0.250 round steel rod having at least about 65 KSI tensile strength is preferred.

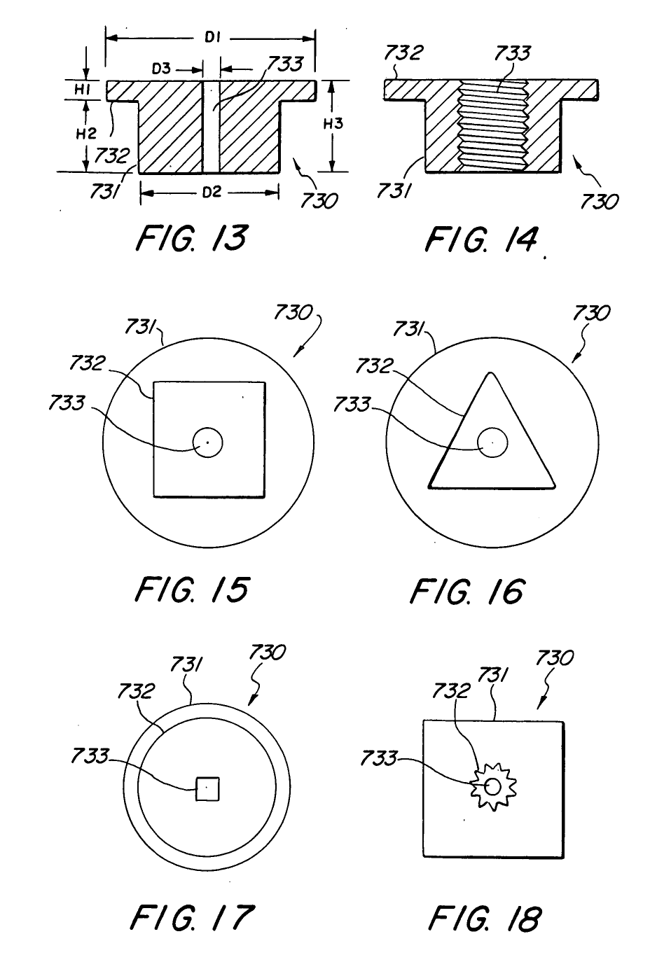

Referring to FIGS. 13-18, coupling mechanism 730 (430 in FIGS. 4 and 5) is preferably a collapsible nylon bushing comprising a body 731, a flange 732 and a through hole 733. In other preferred embodiments, the bushing may be a light weight plastic or foam material. In alternative embodiments, coupling mechanism 730 may use other materials or composites, and may utilize multi-piece coupling mechanisms. Through hole 733 may comprise a smooth surface as shone in FIG. 13, a threaded surface as shown in FIG. 14, or some other surface adapted to retain a fastener assembly. Coupling mechanism 730 may have a variety of shapes, and in some instances the shape of the flange may differ from the shape of the body, and/or the shape of the through hole. Although any reasonable shape may be used, FIGS. 15-18 provide a sampling of alternatives to the cylindrical body, flange, and through hole of FIG. 13. In FIG. 15 a cubic body is used with a cylindrical flange and through hole. In FIG. 16 a prismatic body is used with a cylindrical flange and through hole. In 17 a cylindrical flange and boy are used with a cuboid through hole, and in FIG. 18, a cuboid flange is used with a prismatic body and cylindrical through hole.

As shown in FIG. 13, a preferred coupling mechanism comprises a flange outer diameter D1, a body outer diameter D2, a through hole diameter D3, a flange height/thickness H1, a body height H2, and an overall height/length H3. It is contemplated that the values for D1-D3 and H1-H3 will vary greatly between embodiments depending primarily on the type and size of fastener to be coupled, the size and shape of the fastening loop, the size of the rod used to form the fastening loop, the size and shape of the base, and how the flange 732 and body 731 are preferred to deform when the support structure is fastened to a surface.

In a preferred embodiment, H2 will be at least equal to thickness of the fastening loop it is intended to project into (typically the cross sectional diameter of rod used to form the loop). It is contemplated that if body 731 is sufficiently deformable, having H2 greater than the thickness of the fastening loop will cause body 731 to deform to fill in any open areas of the fastening loop, and to contact a larger surface area of the sides of the fastening loop when compressed between a portion of the fastener assembly and a surface to which the support assembly is being coupled. Similarly, flange 732 can be sized in accordance with its composition so that it either deforms such that it is either squeezed into the fastening loop so that the fastening loop can contact the surface the support assembly is being coupled to, or will flatten out and receive the fastening loop.

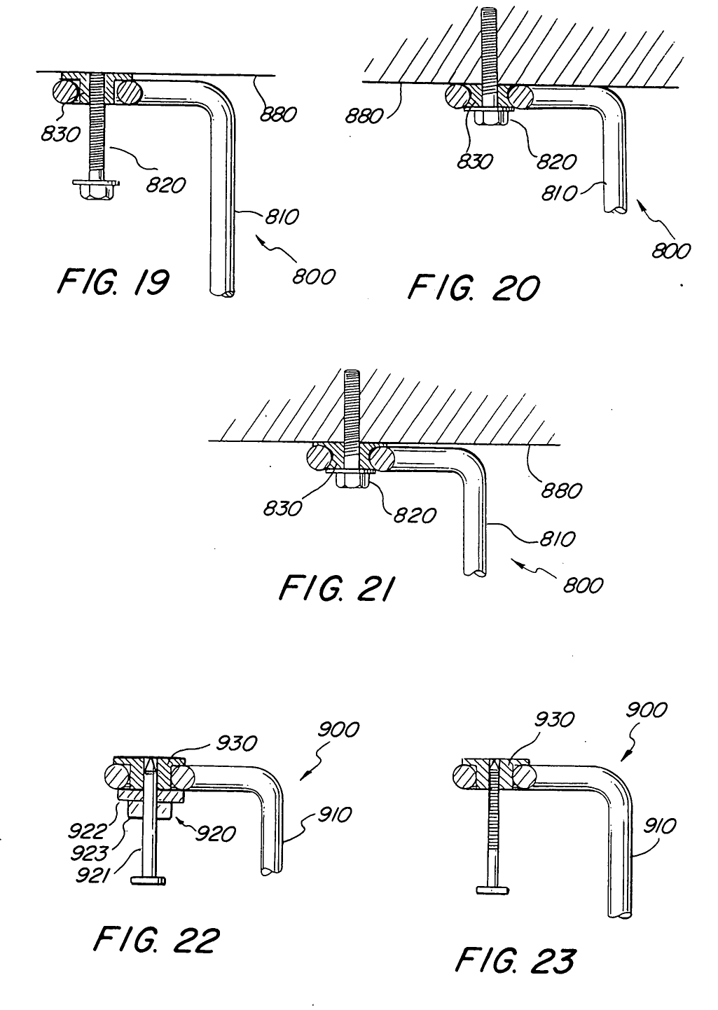

Referring to FIG. 19-21, a support assembly 800 comprises a support 810, a fastener assembly 820, and a fastener coupling mechanism 830. In FIG. 19, the assembly is positioned to be coupled to surface 880. In FIGS. 20 and 21 the assembly is shown coupled to surface 880. In FIG. 20, the coupling mechanism 830 deforms to fill in the space of the fastening loop but does not prevent the fastening loop from contacting surface 880. In FIG. 21, the flange coupling mechanism 830 does separate the fastening loop from surface 880. In alternative embodiments, the coupling mechanism may not deform significantly, or may deform in an alternative manner.

It is contemplated that use of a deformable coupling mechanism will in many instances provide for a more rigid coupling of support 810 to surface 880. As it deforms to engage more surface area of the fastening loop and the fastener, it increases the amount of friction between the two and thus in some instances may act to prevent rotation of support 810 around a pin, nail, screw or other fastener of fastening assembly 820. Similarly, any deformation that increases the amount of contact with surface 880 may similarly hinder rotation. If a balance between rigidity and deformability is found, coupling mechanism may also act to hinder linear movement of support 810 along surface 880. In some instances, coupling mechanism 830 may operate to prevent a smaller fastener from slipping out of the fastening loop, and/or to prevent the support 810 from rotating around an axis parallel to the surface 880. In some instances, particularly if support 810 and 880 are extremely rigid, having a deformable flange may provide a cushioning effect that prevents recoil of the support 810 from interfering with insertion of a fastener of fastener assembly 820. Having the coupling mechanism compress may also result in a force perpendicular to the surface to act on a fastener of the fastener assembly, possibly with the result that the fastener is less likely to separate from the surface.

Although a deformable coupling mechanism may provide numerous advantages, use of a non-deformable coupling mechanism may be desirable in some instances. As an example, if support 810 has a substantially planar base and surface 880 is substantially planar, and there is sufficient friction between surface 880 and support 810, coupling mechanism 830 may only be needed to retain the fastening assembly 820, and not needed to deform. In some instances, having at least the body/through hole portion of the coupling mechanism be non-deformable may help in retaining the fastener assembly. Is other instances, a rigid coupling mechanism may be desirable to inhibit movement of support 810 parallel to surface 880.

In some instances, the coupling mechanism may be non-removably formed or inserted in the fastening loop, or may be so tightly fitted within the fastening loop that substantial force is required to remove it. It is contemplated that having the coupling mechanism tightly coupled within the fastening loop may provide advantages in addition to those already described. One such advantage is that the fastener assembly will be more likely to retain a desired orientation even if subjected to external forces if the coupling mechanism is unable to move. In most instances this will be such that a fastener will be perpendicular to the surface it is driven into, while in others, it may be angled relative to that surface. Another advantage is the ability to force a fastener assembly into the coupling mechanism after the coupling mechanism is combined with a support with little risk that the coupling mechanism will be dislodged or re-oriented. It is contemplated that this might allow a coupling mechanism and support subassembly to be pre-formed, and then combined a fastener assembly. If a particular type of coupling mechanism is suitable for use with a variety of fastener types, such a sub-assembly may be used as a generic component in the formation of support structures comprising a variety of fasteners.

If the coupling mechanism is loosely fitted into the fastening loop, it is contemplated that providing the coupling mechanism with a planar flange and a through hole that tightly engages a fastener will also assist in orientating the fastener. In such an instance, sandwiching the flange between the fastening loop and the surface will cause the flange to be parallel to the surface and thus orient the fastener, even if there is not a tight fit between the coupling mechanism and the fastening loop.

Coupling mechanism 830 is preferably moveably, and possibly removeably coupled to a fastener of fastener assembly 820 so that the fastener can move through the through hole 833 into surface 880. Having mechanism 830 be removeably coupled may be an advantage if it is desirable to be able to replace the fastener used with support, but may be a disadvantage if the support assembly is subjected to forces that might separate the fastener assembly from the support. In the preferred embodiment the coupling mechanism engages an external surface of a fastener with sufficient force to prevent the fastener assembly from separating from the support, but with a weak enough force that such that the fastener can be driven into a surface, and/or possibly manually removed from the support.

Retention of fastener assembly 820 is preferably accomplished by having a portion of a fastener of the assembly pushed into a through hole of the coupling mechanism 820 such that the flange and a washer or head of the fastener assembly move towards each other and engage the upper and lower surfaces of the fastening loop.

Referring back to FIGS. 4 and 5, fastener assembly 430 may be any type of fastener suitable for coupling support 410 to surface 480, but will typically be determined at least in part by the type of surface 480. As such, fastener 430 may be, among others, a wood nail, wood screw, metal screw, concrete nail, or concrete anchor. It is contemplated that it may be particularly advantageous to have fastener 430 be a timber pin for wood, a ramset for concrete, and a drill screw for a metal deck. FIGS. 22 and 23 illustrate alternative fastener assemblies. In FIG. 22, fastener assembly comprises a nail/pin 921, a plate/washer 922, and a bushing 923.

The present invention may be characterized as a cable support structure comprising a unitary support member; a fastener assembly having a portion projecting outward from the support member; and a coupling assembly adapted to couple the fastener assembly to the support member, the coupling assembly comprising a flange positioned opposite the projection portion of the fastener assembly. Some embodiments satisfy one or more of the following characterizations in any combination as well: (a) the support member is formed by bending an elongated rod to form a fastening loop; (b) the fastening loop defines a plane, and the support member comprises a second bend that causes a drop segment to project outward from the plane; (c) the support member comprises a stabilizing segment between the fastening loop and second bend wherein the stabilizing segment is substantially coplanar with the plane defined by the fastening loop; (d) the drop segment is substantially perpendicular to the plane; (e) the stabilizing loop has an inner diameter of between ¼ and ⅜ inches (preferably 5/16 inches), the base is at least 1½ inches long, the rod at least 0.245 inches in diameter (and preferably between 0.246 and 0.252 inches in diameter) and the drop segment is at least six inches long; and/or (f) the fastener assembly comprises a wood nail, wood screw, metal screw, concrete nail, or concrete anchor.

The previously described embodiments and/or additional embodiments may also satisfy one or more of the following characterizations in any combination: (a) the flange is compressible; (b) the support member comprises a fastening loop having an inner diameter, the fastener assembly passes through the fastening loop and projects outward from a first side of the support member, and the compressible flange has an outer diameter greater than the inner diameter of the fastening loop and is positioned on a second side of the support member that is opposite of the first side; (c) the fastener assembly project outward from the first side of the support member by at least ¼ inch, and either does not project outward from the second side, or extends outward from the second side by less then ¼ inch; (d) the fastener assembly projects outward from the first side of the support member by at least ¼ inch, and does not extend outward from the second side beyond the compressible flange; (e) the coupling assembly comprises a body having first end, a second end, a through hole passing through the body from the first end to the second end, and the flange is positioned at or near the first end; (f) the flange is substantially coaxial with the through hole; (g) the through hole has a diameter that is less than or equal to the outer diameter of a fastener member of the fastener assembly; (h) the body has an external diameter less than the inner diameter of the fastening loop; (i) the body has an external diameter greater or equal to the inner diameter of the fastening loop; (j) the body and flange are each part of a single unitary member; (k) the member is a nylon bushing; and/or (l) the fastener assembly comprises a wood nail, wood screw, metal screw, concrete nail, or concrete anchor.

The present invention may also be characterized as a method of forming a cable support structure such as those of the previously described embodiments where the method comprises: forming unitary support member by bending a steel rod to form a fastening loop, an adjacent stabilizing segment, and a drop segment separated from the stabilizing segment by a bend in the rod; providing a fastener assembly comprising an elongated fastener and a washer; providing a coupling member having a flange and a through hole; coupling the fastener assembly to the support member by causing an end of the elongated fastener to pass through at least a portion of the fastening loop and forcing the coupling member and fastener together such that the elongated fastener projects outward from a first side of the fastening loop, and the flange is positioned on a second side of the fastening loop opposite the first side. Embodiments of such a method may also satisfy the following characterization: the fastener and coupling member are provided together, and coupling the fastener assembly to the support member comprises first separating the fastener and coupling member.

Yet another possible characterization of the present invention is as a fastener assembly comprising a fastener having a head, and a bushing having a flange, wherein the fastener and bushing are removeably coupled together to form an elongated assembly wherein the head and bushing are positioned at or near opposite ends of the assembly.

Still another characterization of the present invention is as a support structure for suspending electrical cable in the plenum above a suspend ceiling attached to an upper support, the support structure for electronic cable comprising: a unitary structure having a drop segment extending downward from a stabilizing segment, the stabilizing segment oriented to lay against the upper support, the stabilizer segment formed into a loop at its end; and a coupling mechanism for attaching the stabilizing segment to the upper support by the loop in the stabilizing segment. Some embodiments satisfy one or more of the following characterizations in any combination as well: the stabilizing loop has an inner diameter of at least 0.26 inches, the distance between a point on the loop and a point on the stabilizing segment is at least 1.5 inches, the drop segment is at least six inches long, and the support member is formed from a mild steel rod having a diameter of at least 0.2 inches.

1. A support structure for suspending electrical cable in the plenum above a suspend ceiling attached to an upper support, the support structure for electronic cable comprising:
a unitary structure having a drop segment extending downward from a stabilizing segment, the stabilizing segment oriented to lay against the upper support, the stabilizer segment formed into a loop at its end; and
a coupling mechanism for attaching the stabilizing segment to the upper support by the loop in the stabilizing segment.

2. The structure of claim 1 wherein at least two points positioned on the loop are separated by a distance of at least X inches where X is one of 0.75, 0.80, 0.85, and 0.90.

3. The structure of claim 1 wherein the base has a length of at least L inches where L is one of 1.5 and 1.75.

4. The structure of claim 1 wherein the unitary structure is formed from a rod having a diameter of at least 0.24 inches.

5. The structure of claim 1 wherein the coupling mechanism comprises
a fastener assembly having a portion projecting outward from the loop;
and a bushing adapted to couple the fastener assembly to the loop, the bushing comprising a flange positioned opposite the projection portion of the fastener assembly.

6. The structure of claim 5 wherein the flange is compressible.

7. The structure of claim 6 wherein:
the support member comprises a fastening loop having an inner diameter;
the fastener assembly passes through the fastening loop and projects outward from a first side of the support member; and
the compressible flange has an outer diameter greater than the inner diameter of the fastening loop and is positioned on a second side of the support member that is opposite of the first side.

8. A cable support structure comprising:
a unitary support member;
a fastener assembly having a portion projecting outward from the support member;
and a coupling assembly adapted to couple the fastener assembly to the support member, the coupling assembly comprising a flange positioned opposite the projection portion of the fastener assembly.

9. The structure of claim 8 wherein the support member is formed by bending an elongated rod to form a fastening loop.

10. The structure of claim 9 wherein the fastening loop defines a plane, and the support member comprises a second bend that causes a drop segment to project outward from the plane.

11. The structure of claim 10 wherein the support member comprises a stabilizing segment between the fastening loop and second bend wherein the stabilizing segment is substantially coplanar with the plane defined by the fastening loop.

12. The structure of claim 11 wherein the drop segment is substantially perpendicular to the plane.

13. The structure of claim 12 wherein the stabilizing loop has an inner diameter of at least 0.26 inches, the distance between a point on the loop and a point on the stabilizing segment is at least 1.5 inches, the drop segment is at least six inches long, and the support member is formed from a mild steel rod having a diameter of at least 0.2 inches.

14. The structure of claim 13 wherein the fastener assembly comprises a wood nail, wood screw, metal screw, concrete nail, or concrete anchor.

15. The structure of claim 8 wherein the flange is compressible.

16. The structure of claim 15 wherein:
the support member comprises a fastening loop having an inner diameter;
the fastener assembly passes through the fastening loop and projects outward from a first side of the support member; and
the compressible flange has an outer diameter greater than the inner diameter of the fastening loop and is positioned on a second side of the support member that is opposite of the first side.

17. The structure of claim 16 wherein the fastener assembly project outward from the first side of the support member by at least ¼ inch, and either does not project outward from the second side, or extends outward from the second side by less then ¼ inch.

18. The structure of claim 16 wherein the fastener assembly project outward from the first side of the support member by at least ¼ inch, and does not extend outward from the second side beyond the compressible flange.

19. The structure of claim 18 wherein the coupling assembly comprises a body having first end, a second end, a through hole passing through the body from the first end to the second end, and the flange is positioned at or near the first end.

20. The structure of claim 19 wherein the flange is substantially coaxial with the through hole.

21. The structure of claim 20 wherein the through hole has a diameter that is less than or equal to the outer diameter of a fastener member of the fastener assembly.

22. The structure of claim 21 wherein the body has an external diameter less than the inner diameter of the fastening loop.

23. The structure of claim 21 wherein the body has an external diameter greater or equal to the inner diameter of the fastening loop.

24. The structure of claim 23 wherein the body and flange are each part of a single unitary member.

25. The structure of claim 24 wherein the member is a nylon bushing.

26. The structure of claim 25 wherein the fastener assembly comprises a wood nail, wood screw, metal screw, concrete nail, or concrete anchor.

27. A method of forming the cable support structure of claim 1, comprising:
forming unitary support member by bending a steel rod to form a fastening loop, an adjacent stabilizing segment, and a drop segment separated from the stabilizing segment by a bend in the rod;
providing a fastener assembly comprising an elongated fastener and a washer;
providing a coupling member having a flange and a through hole;
coupling the fastener assembly to the support member by causing an end of the elongated fastener to pass through at least a portion of the fastening loop and forcing the coupling member and fastener together such that the elongated fastener projects outward from a first side of the fastening loop, and the flange is positioned on a second side of the fastening loop opposite the first side.

28. The method of claim 27 wherein the fastener and coupling member are provided together, and coupling the fastener assembly to the support member comprises first separating the fastener and coupling member.

29. A fastener assembly comprising a fastener having a head, and a bushing having a flange, wherein the fastener and bushing are removeably coupled together to form an elongated assembly wherein the head and bushing are positioned at or near opposite ends of the assembly.
